(19) United States
(12) Patent Application Publication
(10) Pub. No.: US 2013/0047260 A1
(43) Pub. Date: Feb. 21, 2013

(54) COLLABORATIVE CONTENT RATING FOR ACCESS CONTROL

(71) Applicants: Guilherme Luiz Karnas Hoefel, San Diego, CA (US); Hugo Swart, San Diego, CA (US); Khaled Helmi El-Maleh, San Marcos, CA (US); Luis Mirabal, San Diego, CA (US)

(72) Inventors: Guilherme Luiz Karnas Hoefel, San Diego, CA (US); Hugo Swart, San Diego, CA (US); Khaled Helmi El-Maleh, San Marcos, CA (US); Luis Mirabal, San Diego, CA (US)

(73) Assignee: QUALCOMM Incorporated, San Diego, CA (US)

(21) Appl. No.: 13/210,544

(22) Filed: Aug. 16, 2011

(51) Int. Cl. G06F 21/24

(52) U.S. Cl. 726/27

(57) ABSTRACT

Methods, systems, devices, and computer program products are described for controlling access to electronic content. Content ratings for electronic content are received from each of a number of reviewers, and the input value for each of the reviewers is weighted. Content analysis for the electronic content is also received on each of a number of factors, and each factor is weighted. These weightings may be based on community standards, be specific to a geographic region, or be personalized. The weighted content ratings and the weighted content analysis may be combined to generate an access metric. Access to the electronic content may be controlled based on the access metric.

CROSS REFERENCES

This application is related to the following co-pending U.S. patent application, entitled “PLAY TIME DISPENSER FOR ELECTRONIC APPLICATIONS” having Qualcomm Docket No. 102683, filed concurrently herewith, assigned to the assignee hereof, and expressly incorporated by reference herein for all purposes.

### BACKGROUND

The following relates generally to controlling access to electronic content, and more specifically to using a collaborative content rating and content analysis to control access. The type and amount of electronic content available over the Internet has been increasing at a staggering rate. This electronic content often can be readily searched and downloaded, and can provide rich educational experiences and valuable information.

However, there are a range of entities (e.g., parents, schools, and workplaces) that face a supervision challenge in controlling access to the Internet and other forms of electronic content. Dictating which content is appropriate in different situations can be difficult because content viewers are diverse, and analyzing content as access is attempted is difficult logistically. Current web filters and parental access controls are often unable to block electronic content effectively. There may, therefore, be a need in the art for novel access control functionality for electronic content.

### SUMMARY

The described features generally relate to one or more systems, methods, devices, and computer program products for controlling access to electronic content. Further scope of the applicability will become apparent from the following detailed description, claims, and drawings. The detailed description and specific examples are given by way of illustration only, since various changes and modifications within the spirit and scope of the description will become apparent to those skilled in the art.

In one example, novel functionality is described for controlling access to electronic content. Content ratings for electronic content are received from each of a number of reviewers, and the input value for each of the reviewers is weighted. Content analysis for the electronic content is also received on each of a number of factors, and each factor is weighted. These weightings may be based on community standards, be specific to a geographic region, or be personalized. The weighted content ratings and the weighted content analysis may be combined to generate an access metric. Access to the electronic content may be controlled based on the access metric.

In one example, a method of controlling access to electronic content includes: receiving content ratings for electronic content from each of a number of reviewers, weighting an input value for each of the reviewers, receiving content analysis for the electronic content on each of a number of factors, and weighting each of the factors. Using a computer system, the weighted content ratings and the weighted content analysis are combined to generate an access metric, and access to the electronic content is controlled responsive to the generated access metric.

The method may include identifying an access metric threshold applicable to a content viewer, wherein the controlling access comprises applying the generated access metric to the identified access metric threshold. The method may include identifying a location, wherein the weighting of the input value and the weighting of the content analysis comprise weighting the input value and weighting the content analysis according to the location. In one example, the method may include weighting the input value and weighting the content analysis according to a location of a content viewer.

The method may include weighting the input value and weighting the content analysis according an age of a content viewer. The method may include weighting the input value and weighting the content analysis according to a first weighting for a first daily time period, and weighting the input value and weighting the content analysis according to a second weighting for a second daily time period. The method may include weighting the input value and weighting the content analysis according to a type of activity being undertaken by a content viewer. The method may include weighting the input value and weighting the content analysis according to a specification of a content control user.

The method may include transmitting the content control user a first option to accept community standard for controlling access and a second option for a personalized standard for controlling access, and receiving, in response to the transmission, the specification for the first option or the second option from the content control user. The method may further include a community standard comprising a content control user-selectable geographic region, or a content control user-selectable organization. The method may further include receiving specification of an access standard applicable to a content viewer from a content control user. The content control user may be a parent, and a content viewer may be a child of the parent. The content control user may be a teacher or education-related entity, and a content viewers may be students.

The method may include receiving a request to access the electronic content from a content viewer, wherein controlling access comprises applying the generated access metric to characteristics of the content viewer. The method may include transmitting an access control message to a content viewer device. The method may include a plurality of factors comprising profanity, violence, sexual content, drug references, and educational value. The method may include crawling a plurality of web pages to analyze text and images. The method may include a computer system comprising a central server computer system and a content viewer device, and electronic content comprising internet content, video programming, or electronic gaming.

In one example, a computer program product for controlling access to electronic content includes a non-transitory computer-readable medium comprising code for receiving a plurality of content ratings for electronic content from each of a plurality of reviewers, code for weighting an input value for each of the plurality of reviewers, code for receiving content analysis for the electronic content on each of a plurality of factors, code for weighting each of the plurality of factors, code for combining the weighted content ratings and the weighted content analysis to generate an access metric, and code for controlling access to the electronic content responsive to the generated access metric.

In one example, a system of controlling access to electronic content includes means for receiving a plurality of content ratings for electronic content from each of a plurality of reviewers, means for weighting an input value for each of the plurality of reviewers, means for receiving content analysis for the electronic content on each of a plurality of factors, means for weighting each of the plurality of factors, means for combining the weighted content ratings and the weighted content analysis to generate an access metric, and means for controlling access to the electronic content responsive to the generated access metric.

The system may include the means for identifying an access metric threshold applicable to a content viewer, wherein the controlling access comprises applying the generated access metric to the identified access metric threshold. The system may include means for identifying a location of a content viewer, wherein the means for weighting of the input value and the means for weighting of the content analysis comprise means for weighting the input value and weighting the content analysis according to the identified location. The system may include means for weighting the input value and weighting the content analysis according to a geographic region specified by a content control user. The system may include means for weighting the input value and weighting the content analysis according to the age of a content viewer.

The system may include means for weighting the input value and weighting the content analysis according to a first weighting for a first daily time period, and weighting the input value and weighting the content analysis according to a second weighting for a second daily time period. The system may include means for weighting the input value and weighting the content analysis according to a type of activity being undertaken by a content viewer. The system may include means for weighting the input value and weighting the content analysis according to a specification of a content control user. The system may further include means for transmitting to the content control user a first option to accept community standard for controlling access and a second option for a personalized standard for controlling access, and means for receiving, in response to the transmission, the specification for the first option or the second option from the content control user. The community standard may be a content control user-selectable geographic region, or a content control user-selectable organization. The system may include means for receiving specification of an access standard applicable to a content viewer from a content control user. The content control user may be a parent, and a content viewer may be a child of the parent. The content control user may be a teacher or education-related entity, and a content viewer may be a set of students.

The system may include means for receiving a request to access the electronic content from a content viewer, wherein the means for controlling access comprises applying the generated access metric to characteristics of the content viewer. The system may include for transmitting an access control message to a content viewer device. The factors may include profanity, violence, sexual content, drug references, or educational value. The system may include means for crawling a plurality of web pages to analyze text and images. The system may include a computer system comprising a central server computer system and a content viewer device, and electronic content comprising internet content, video programming, or electronic gaming.

In one example, a device for controlling access to electronic content may include a content reviewer module configured to receive a content ratings for electronic content from each of a number of reviewers; a content analysis module configured to receive content analysis for the electronic content on each of a number of factors; a weighting module communicatively coupled with the content reviewer module and content analysis module and configured to weight an input value for each of the plurality of reviewers, weight each of the plurality of factors, and combine the weighted content ratings and the weighted content analysis to generate an access metric. the device may include an access control module communicatively coupled with the weighting module and configured to control access to the electronic content responsive to the generated access metric.

The device may include a content control user module, communicatively coupled with the weighting control module, and configured to transmit to a content control user a first option to accept a community standard for controlling access and a second option to select a personalized standard for controlling access, and receive, in response to the transmission, a specification for the first option or the second option from the content control user.

### BRIEF DESCRIPTION OF THE DRAWINGS

A further understanding of the nature and advantages of the present invention may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 is a block diagram illustrating a communications system;

FIG. 2 is a block diagram of a system for controlling access to electronic content;

FIG. 3 is a block diagram of an alternative architecture for a system to control access to electronic content;

FIG. 4 is a block diagram of a system content reviewer module, content analysis module, and weighting module for controlling access to electronic content;

FIG. 5 is a block diagram of a content control user interface;

FIG. 6 is a flowchart of a method for controlling access to electronic content;

FIG. 7 is a flowchart of a method for controlling access to electronic content based on the characteristics of a content viewer; and

FIG. 8 is a flowchart of a method for controlling access to electronic content based on preferences of a content control user.

### DETAILED DESCRIPTION

The following description generally relates to controlling access to electronic content, and more specifically to using a collaborative content rating and content analysis to control access. Novel functionality is described for controlling access to electronic content (e.g., Internet content, video entertainment, electronic gaming). Content ratings for electronic content are received from each of a number of reviewers, and the input value for each of the reviewers is weighted. Content analysis for the electronic content is also received on each of a number of factors (e.g., profanity, violence, etc.), and each factor is weighted. These weightings may be based on community standards, be specific to a geographic region, or be personalized. The weighted content ratings and the weighted content analysis may be combined to generate an access metric. Access to the electronic content may be controlled based on the access metric.

In one example, a web browser plug-in is configured to allow reviewers (e.g., parents and interested parties) to rate websites according to their appropriateness for children. A centralized system aggregates the information from the plug-ins, and creates ratings. These ratings may be weighted according to reviewer. The centralized system may also crawl the web, and analyze the websites according to a range of factors (e.g., profanity, sexual content, and violence). These factors may be weighted as well. The centralized system, or a client application, may provide conditional access to web resources based on the weighted collaborative ratings and weighted factors. The weightings, and thus the access decision, may be applied according to age, time of the day, type of activity being performed, etc. A content controller (e.g., a parent) may choose to use this conditional access as is, and provide no additional input. Others may instead tweak this conditional access based on some personal customization. This conditional access scheme may be deployed by making all the traffic be re-routed to a server with this capability, or by being pushed to the device from which the user will be accessing the Internet.

The following description provides examples, and is not limiting of the scope, applicability, or configuration set forth in the claims. Changes may be made in the function and arrangement of elements discussed without departing from the spirit and scope of the disclosure. Various embodiments may omit, substitute, or add various procedures or components as appropriate. For instance, the methods described may be performed in an order different from that described, and various steps may be added, omitted, or combined. Also, features described with respect to certain embodiments may be combined in other embodiments.

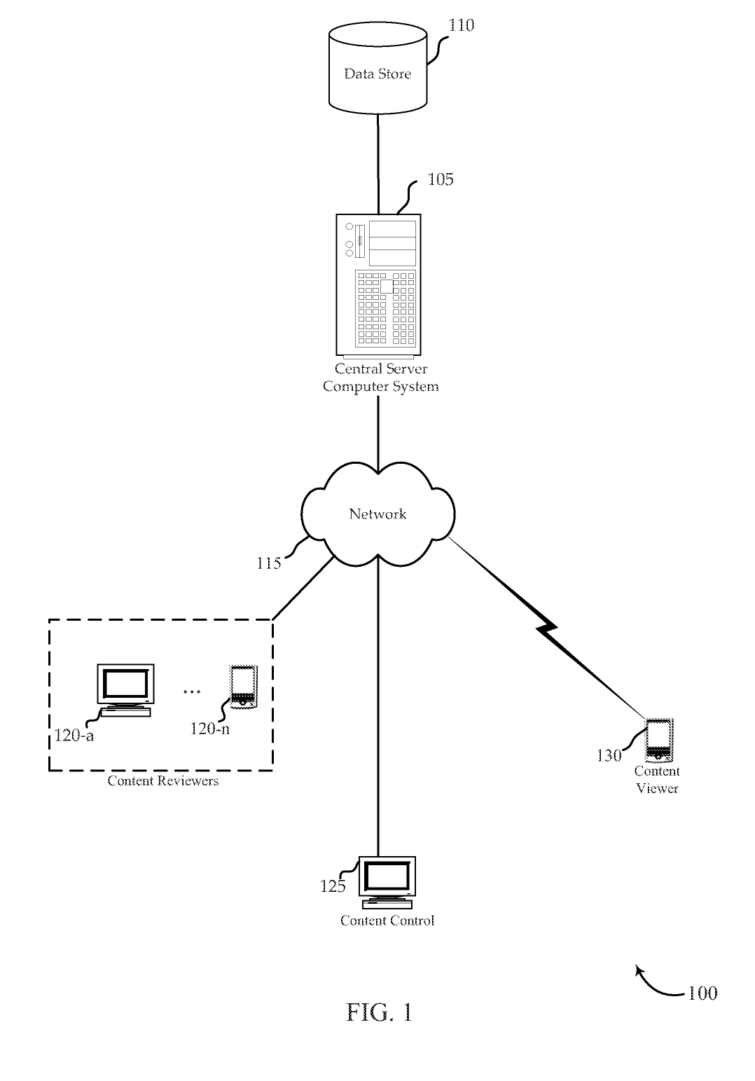

Referring first to FIG. 1, system 100 includes a central server computer system 105, data store 110, network 115, content reviewers 120, content control 125, and content viewer 130. Each of these components may be in communication with each other, directly or indirectly. The system may be configured to control access to electronic content (e.g., preventing or allowing access to web pages, video programming, or electronic games).

The central server computer system 105 may receive content ratings for electronic content from each of the content reviewers 120. The central server computer system 105 may weight an input value to be associated with each of the content reviewers 120. The central server computer system 105 may perform and receive content analysis for the electronic content, based on each of a number of factors (e.g., profanity, violence, etc.). For example, the central server computer system 105 may crawl the Internet to retrieve data and perform analysis on the electronic content. Each factor may be weighted. Weightings for reviewers and factors may be based on community standards, be specific to a geographic region, or be personalized. The central server computer system 105 may combine the weighted reviewer inputs and the weighted content analysis to generate an access metric. The central server computer system 105 may control (e.g., block or allow) access to the electronic content based on the access metric.

The central server computer system 105 may be made up of one or more server computers, workstations, web servers, or other suitable computing devices. It may be fully located within a single facility or distributed geographically, in which case a network may be used to integrate different components. Although the illustrated embodiment shows that a central server computer system 105 performs the access control and related functions, in other examples these functions may be performed by distributed computing devices.

A content reviewer 120, content control 125, or content viewer 130 may be a personal computer, laptop, tablet, personal digital assistant (PDA), thin client, mobile device, cellular telephone, or any other computing device, and may have wired or wireless connections to the central server computer system 105.

A content reviewer 120 may provide ratings on various metrics for electronic content, transmitting the information to the central server computer system 105. In one example, the ratings may be provided by a browser plug-in. A content reviewer may review various forms of electronic content, such as web pages, video and other multimedia content, electronic gaming, and so on. A rating may be thumbs up/thumbs down, a scaled rating, or an age cut-off. The rating may be for specific factors, such as profanity, sexual content, violence, or drug references. The central server computer system 105 may weight the input of the content reviewer 120 based on the current location, residence location, school district, place of birth, age, gender, children's age(s), organizational affiliations, or employer associated with the content reviewer 120.

The central server computer system 105 may also perform and receive analysis of electronic content. The central server computer system 105 may, for example, crawl the Internet to retrieve and evaluate images and text. The electronic content may be evaluated based on a number of factors, such as profanity, sexual content, violence, drug references, educational value, historical value, and so. The central server computer system 105 may also include a weighting module configured to weight the information provided.

The central server computer system 105 may weight the input of the content reviewer 120 and the electronic content factors based on a number of criteria. The weights may be based on the user age, current location, or user residence location of the content viewer 130, the time or time period of the day, or the activity being undertaken by the content viewer 130. The central server computer system 105 may combine the weighted reviewer ratings and the weighted content analysis to generate an access metric. The central server computer system 105 may control (e.g., block or allow) access to the electronic content based on the access metric. There may be general access control criteria, age-based criteria, geographic region-specific criteria, content control user specified criteria, or any combination thereof. A content control 125 user may be a parent, teacher, school, school district, employer, or other organization, while a user of the content viewer 130 may be child, student, employee, etc.

In one example, the central server computer system 105 may transmit to the content control 125 a first option to accept a community standard for controlling access and a second option for a personalized standard for controlling access. The community standard may be a content control user-selectable geographic region, or a content control user-selectable organization. The content control 125 user may specify use of the first or second option.

The content control 125 user may specify particular weightings to apply to the content viewer 130. For example, a content control 125 user may set specific weights to ratings and analysis for profanity, sexual content, violence, drug references, educational value, or historical value. The content control 125 user may specify that ratings from reviewers associated with certain organizations or employers be given certain weights. Friends, age ranges, genders, children's ages, etc. may also be given certain weights by the content control 125 user.

A content viewer 130 may attempt to access electronic content (e.g., by attempting to access a web page, or access a video, or play an electronic game). Characteristics of the user of the content viewer 130 may be provided to or accessed by the central server computer system 105 (e.g., age, geographic region, association with organization or content control 125 user). Weights of the input of the reviewers and the electronic content factors may be applied based on these characteristics.

The reviewer data, content analysis, weightings, content control user preferences or selections, or content viewer characteristics may be stored locally by the central server computer system 105, or may be stored (in whole or in part) at data store 110. Data store 110 may be a single database, or may be made up of any number of separate and distinct databases. The data store 110 may include one, or more, relational databases or components of relational databases (e.g., tables), object databases, or components of object databases, spreadsheets, text files, internal software lists, or any other type of data structure suitable for storing data. Thus, it should be appreciated that a data store 110 may each be multiple data storages (of the same or different type), or may share a common data storage with other data stores. Although in some embodiments the data store 110 may be distinct from a central server computer system 105 or, in other embodiments it may be integrated therein to varying degrees.

The central server computer system 105, data store 110, network 115, content reviewers 120, content control 125, and content viewer 130 may be directly connected or connected via a network 115, which may include both wired and wireless connections, including optical links. The network may be any, or any combination of, the following: the Internet, an IP network, an intranet, a wide-area network (“WAN”), a local-area network (“LAN”), a virtual private network, the Public Switched Telephone Network (“PSTN”), or any other type of network supporting data communication between devices described herein. In the discussion, a network may or may not be noted specifically. If no specific means of connection is noted, the link, communication, or other connection between devices may be via a network.

The central server computer system 105, or a client application on the content viewer 130, may control access to electronic content. This conditional access scheme may be deployed by making all the traffic be re-routed through the central server computer system 105, or by being pushed to the content viewer 130 from which the user will be accessing the Internet.

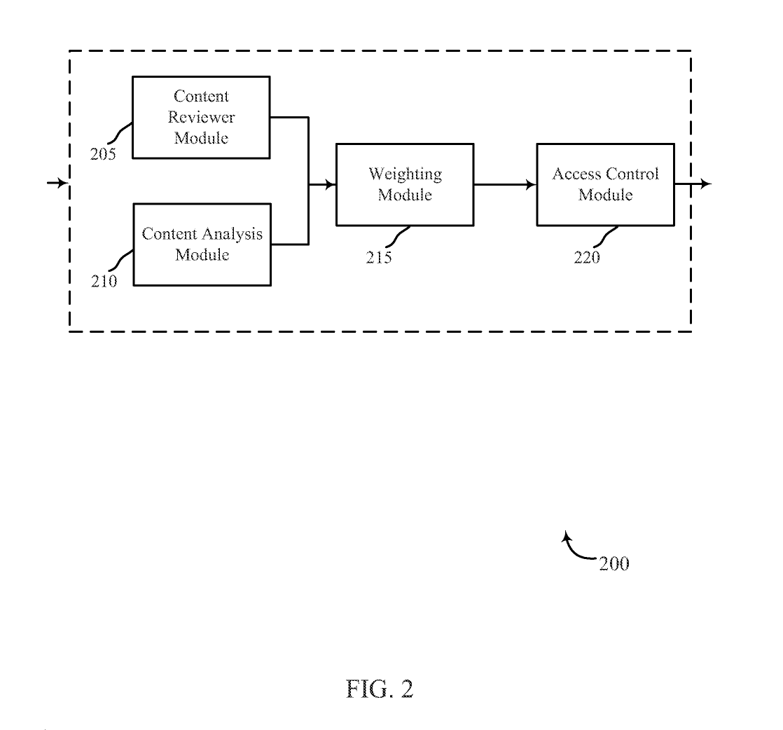

Referring next to FIG. 2, a block diagram 200 illustrates a central server computer system 105-a, which includes a content reviewer module 205, a content analysis module 210, a weighting module 215, and an access control module 220. Each of these components may be in communication with each other, directly or indirectly. The central server computer system 105-a may be configured to control access to electronic content (e.g., preventing or allowing access to web pages, video programming, or electronic games). The central server computer system 105-a may be the central server computer system 105 of FIG. 1.

The content reviewer module 205 may receive a number of content ratings for electronic content from each of a number of reviewers (e.g., the content reviewers 120 of FIG. 1). The received ratings may be simple (e.g., a thumbs up/thumbs down), a scaled rating, or a suggested age cut-off. The rating may be for specific factors, such as profanity, sexual content, violence, or drug references.

The content analysis module 210 may receive content analysis based on electronic content. In one example, the content analysis module 210 may crawl the web to retrieve and analyze electronic content. The content analysis for the electronic content on each of a number of factors, such as profanity, sexual content, violence, drug references, educational value, and historical value.

The weighting module 215 may weight an input value for each of the reviewers, and weight each of the factors. The weighting module 215 may combine the weighted content ratings and the weighted content analysis to generate an access metric. The weights may be based on the user age, current location, or residence location, the time of day, or the activity being undertaken. There may be generalized weightings, age-based weightings, geographic region-specific weightings, personalized access control user weightings, or any combination thereof. The weighting scheme may be controlled, in whole or in part, by a parent, teacher, school, school district, employer, or other organization. The access control module 220 may be configured to control access to the electronic content responsive to the generated access metric.

The components of the central server computer system 105 of FIG. 1 or 2, may, individually or collectively, be implemented with one or more Application Specific Integrated Circuits (ASICs) adapted to perform some or all of the applicable functions in hardware. Alternatively, the functions may be performed by one or more other processing units (or cores), on one or more integrated circuits. In other embodiments, other types of integrated circuits may be used (e.g., Structured/Platform ASICs, Field Programmable Gate Arrays (FPGAs), and other Semi-Custom ICs), which may be programmed in any manner known in the art. The functions of each unit may also be implemented, in whole or in part, with instructions embodied in a memory, formatted to be executed by one or more general or application-specific processors.

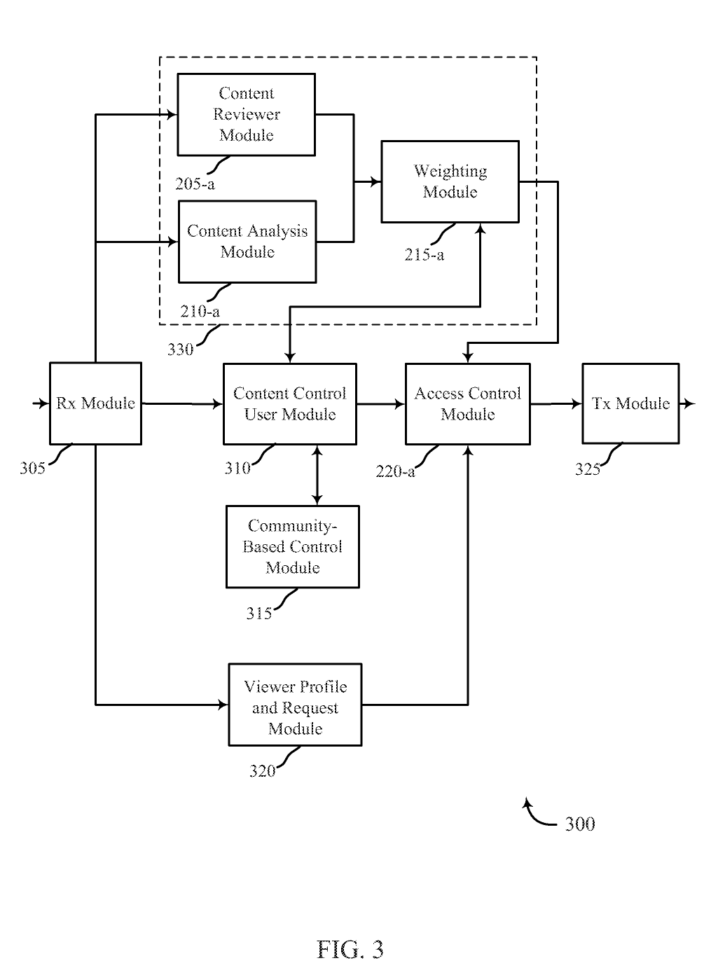

Referring next to FIG. 3, a block diagram illustrates a system 300. The system 300 may be the central server computer system 105 of FIG. 1 or 2, or may be distributed among other types of computing devices. The system 300 includes receiver module 305, content control user module 310, community-based control module 315, access control module 220-a, viewer profile and request module 320, transmitter module 325, and content module 330. Content module 330 includes content reviewer module 205-a, content analysis module 210-a, and weighting module 215-a. Each of these components may be in communication with each other, directly or indirectly. The system may be configured to control access to electronic content.

The content reviewer module 205-a may receive a number of content ratings for electronic content from each of a number of reviewers (e.g., the content reviewers 120 of FIG. 1) via receiver module 305. The content analysis module 210-a may receive content analysis on the electronic content via receiver module 305.

The content control user module 310 may receive selections from a content control user (e.g., a parent, teacher, or organization) for particular weightings to apply to a content viewer (e.g., a child, student, or employee). For example, a content control user (e.g., the user of content control 125 of FIG. 1) may set specific weights to ratings and analysis for profanity, sexual content, violence, drug references, educational value, or historical value. The content control user may specify that ratings from reviewers associated with certain organizations or employers be given certain weights. The content control user may specify that ratings from friends, reviewer age ranges, reviewer children's ages, etc. may also be given certain weights. Thus, a content control user module 310 may receive specification of an access standard applicable to a content viewer from a content control user. A content control user module 310 may receive various selections for controlling access from a content control user, such as age-based control, age- and community-based control, and personalized control. In addition to the content control user module 310, there may be a community-based control module 315 configured to apply community standards to access control. For a community-based standard, there may be general access control criteria, age-based criteria, geographic region-specific criteria, or any combination thereof

The weighting module 215-a may weight the input of the reviewer (from content reviewer module 205-a) and the content analysis (from content analysis module 210-a) based on a number of criteria. A weighting scheme may be based on weighting information from the content control user module 310 and community-based control module 315, and may also or alternatively be based on viewer age, current location, viewer residence, the time of day, or the activity being undertaken. The weighting module 215-a may combine the weighted reviewer ratings and the weighted content analysis to generate an access metric. The weighting module 215-a may control (e.g., block or allow) access to the electronic content based on the access metric.

Viewer profile and request module 320 may store viewer characteristics (age, location, associations with content control users, etc.). Viewer profile and request module 320 may receive a request to access electronic content (e.g., by identifying an attempt to access a web page, access a video, or play an electronic game). Characteristics of the viewer may be forwarded to the access control module 220-a.

The access control module 220-a may be configured to control access to the electronic content responsive to the generated access metric. In one example, the access control module 220-a may identify an access metric threshold applicable to a content viewer, and an access control decision may be made by applying the generated access metric to the identified access metric threshold. The access control module 220-a located on the central server computer system 105 of FIG. 1 may control access to content in any number of ways. In one example, data flows to and from a content viewer may flow through the central server computer system 105, and the access control module 220-a may control the access to content by preventing or allowing the flows. In another example, the access control module 220-a may transmit an access control message (e.g., via transmitter module 325) to a content viewer, thereby controlling access.

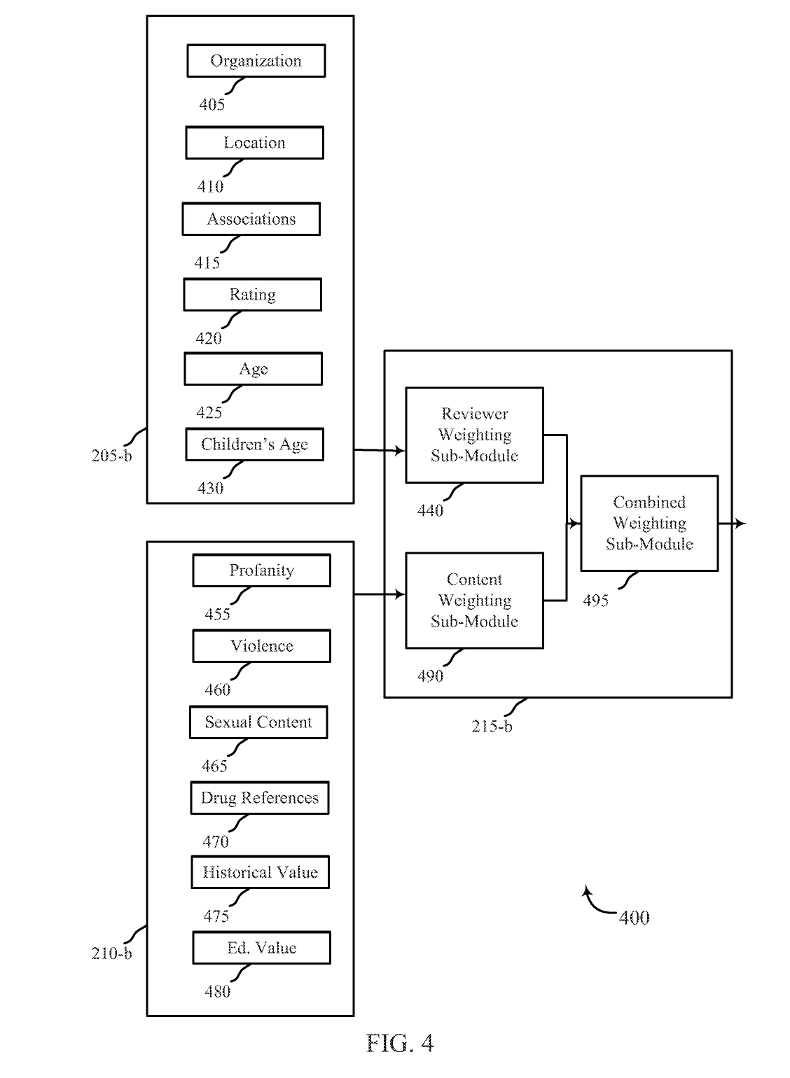

Referring next to FIG. 4, a block diagram illustrates an example configuration of a content reviewer module 205-b, a content analysis module 210-b, and a weighting module 215-b. These components may be implemented in the central server computer system 105 of FIG. 1 or 2, or the system 300 of FIG. 3. The content reviewer module 205-b includes an organization sub-module 405, location sub-module 410, associations sub-module 415, rating sub-module 420, age sub-module 425, and children's age sub-module 430. The content analysis module 210-b includes a profanity sub-module 455, violence sub-module 460, sexual content sub-module 465, drug references sub-module 470, historical value sub-module 475, and educational value sub-module 480. Weighting module 215-b includes reviewer weighting sub-module 440, content weighting sub-module 490, and combined weighting sub-module 495.

The content reviewer module 205-b may receive a number of content ratings for electronic content from each of a number of reviewers (e.g., the content reviewers 120 of FIG. 1). Various sub-modules may use certain criteria to identify, evaluate, or parse reviewer characteristics for each reviewer, and associate content ratings with reviewer characteristics. The organization sub-module 405 may associate a content rating with an organization affiliated with the reviewer; location sub-module 410 may link a content rating to a reviewer location; association sub-module 415 may link a content rating with other groups, clubs, or interests of a reviewer; rating sub-module 420 may associate a content rating with a rating of the reviewer from others; age sub-module 425 may associate a reviewer age with a content rating; and children's age sub-module 430 may associate a content rating with the children's age(s) of the reviewer. Reviewer weighting sub-module 440 may then weight content ratings according to reviewer characteristics associated with respective content ratings. A weighting scheme may be based on information on viewer age, current location, viewer residence, the time of day, or the activity being undertaken. By way of example, if a viewer who is 10 years old wants to view electronic content, ratings of parents of 9-11 year olds may be weighted more heavily. The weighting scheme may be standardized, or there may be various levels of personalization. For example, some parents may want the reviews from reviewers in certain regions of the country with certain religious affiliations to have greater weight.

The content analysis module 210-b may perform or receive content analysis based on electronic content. In one example, the content analysis module 210-b may crawl the web to retrieve and analyze electronic content. Various sub-modules may use certain criteria to evaluate electronic content, and associate electronic content with certain content metrics. For example, text or images may be analyzed to obtain parameters or metrics on a number of factors. The profanity sub-module 455 may associate electronic content with a profanity metric; violence sub-module 460 may associate electronic content with a metric identifying an amount of violence; sexual content sub-module 465 may associate electronic content with a sexual content metric; drug references sub-module 470 may associate electronic content with a metric identifying an amount of drug references; historical value sub-module 475 may associate electronic content with a historical value metric; and educational value sub-module 480 may associate electronic content with an educational value. Content weighting sub-module 490 may then weight content ratings according to viewer age, current location, viewer residence, the time of day, or the activity being undertaken. By way of example, if a viewer is 6 years old, a violence and profanity metric may be weighted more heavily in making a content access decision than for a viewer who is 14 years old. The weighting scheme may be standardized, or there may be various levels of personalization. For example, some parents may want to allow more educationally valuable content, and weight a violence metric as relatively less important. The combined weighting sub-module 495 may combine the weighted content ratings and weighted content analysis to generate an access metric associated with content. The access metric may be used to make access decisions.

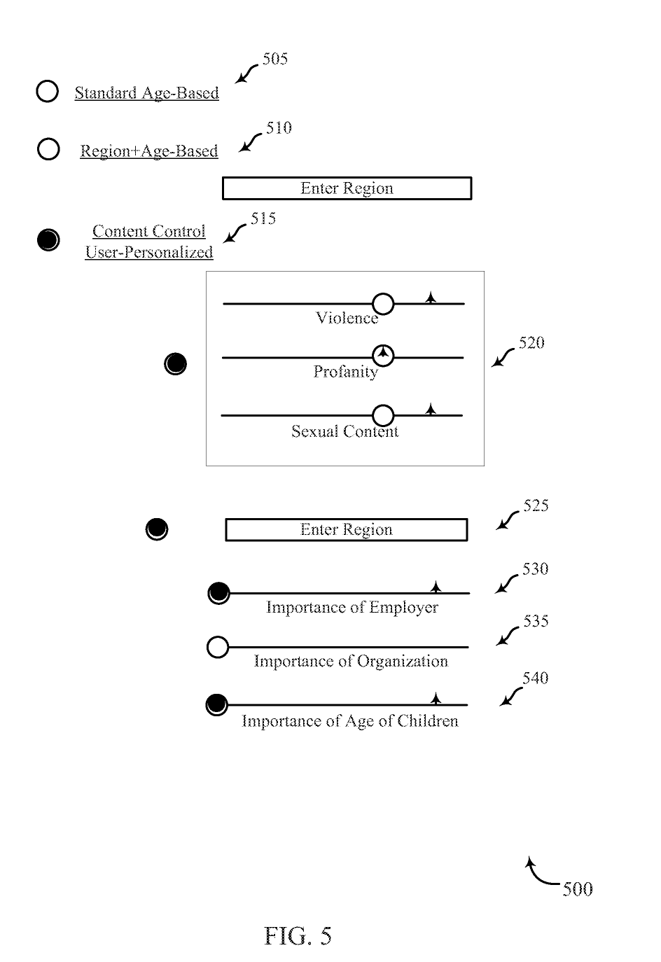

Referring next to FIG. 5, an interface 500 for a content control user (e.g., a parent, teacher, or employer) is illustrated as a block diagram. This interface 500 may be generated at the central server computer system 105 of claim 1 or 2, and be received by content control user (e.g., the content control 125 of FIG. 1). The interface, in other examples, may be generated locally. A content control user may make selections related to the content control applicable to a content viewer or set of viewers (e.g., the content viewer 130 of FIG. 1). These selections may be transmitted back to the central server computer system 105 of FIG. 1 or 2, or the content control user module 310 of FIG. 3. Using this interface 500, a content control user may select how to control access to content, and may do so in a generalized or personalized manner.

The interface allows for three different choices (in other examples, there may be more or fewer choices): standard age-based 505, region+age-based 510, or content control user-personalized 515. A content control user may select a standard age-based 505 scheme, wherein access will be based on standardized age-based metrics. A content control user may select a region+age-based 510 scheme, wherein access will be based on standardized age-based metrics applicable to a region (e.g., a neighborhood, city, metropolitan region, state, or region of the country).

A content control user may select a content control user-personalized 515 scheme, wherein access will be based on personalized selections. A content control user may specify that he or she wants to use a content-based interface 520, wherein it is possible to specify personalized tolerances for violence, profanity, and sexual content. In this example, the circles on the line represent standard tolerance, and the arrows represent content control user-selected tolerances (this user has a higher tolerance for violence and sexual content in this example).

A content control user may specify that he or she wants to make a region selection 525, and thereby have reviewers from the selected region be weighted more heavily. There may other selectable reviewer-based sub-interfaces, including an employer importance sub-interface 530, organizational importance sub-interface 535, and importance of age of children 540 sub-interface. These interfaces may allow a content control user to specify the importance of a reviewer's employer, organizational affiliations, and children's ages, respectively.

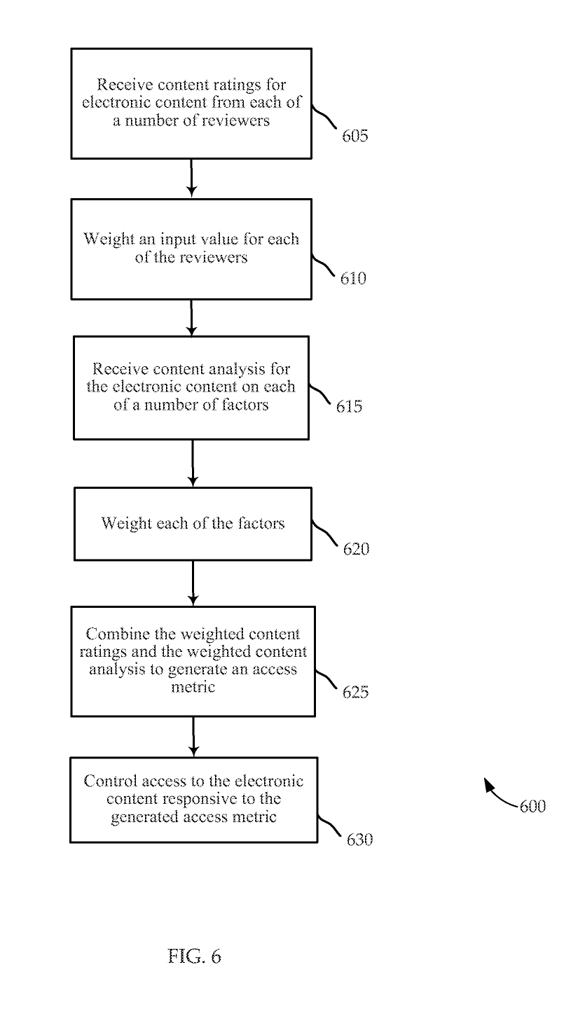

Referring next to FIG. 6, a flowchart is shown illustrating a method 600 for flowchart of a method for controlling access to electronic content. This method 600 may, for example, be performed in whole or in part by the system 100 of FIG. 1, the content viewer 130 of FIG. 1, the central server computer system 105 of FIG. 1 or 2, or the system 300, 400 of FIGS. 3, 4.

At block 605, content ratings are received for electronic content from each of a number of reviewers. At block 610, an input value for each of the reviewers is weighted. At block 615, content analysis for the electronic content is received for each of a number of factors. At block 620, each of the factors is weighted. At block 625, the weighted content ratings and the weighted content analysis is combined to generate an access metric. At block 630, access to the electronic content is controlled responsive to the generated access metric.

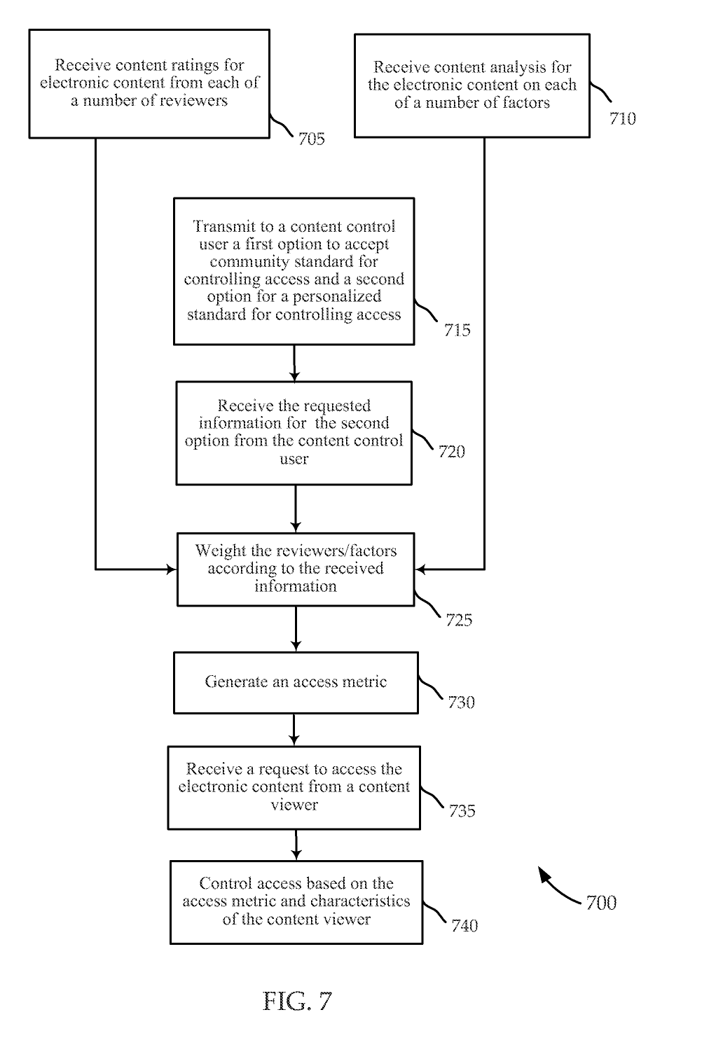

Referring next to FIG. 7, a flowchart is shown illustrating a method 700 for controlling access to electronic content. The method 700 may be the method 600 of FIG. 6. This method 700 may, for example, be performed in whole or in part by the system 100 of FIG. 1, the content viewer 130 of FIG. 1, the central server computer system 105 of FIG. 1 or 2, or the system 300, 400 of FIGS. 3, 4.

At block 705, content ratings for electronic content are received from each of a number of reviewers. At block 710, content analysis for the electronic content is received for each of a number of factors. At block 715, a first option is transmitted to a content control user to accept a community standard for controlling access, and a second option is transmitted to a content control user for a personalized standard for controlling access. At block 720, the requested personalized information for the second option is received from the content control user. At block 725, the reviewers/factors are weighted according to the received information. At block 730, an access metric is generated. At block 735, a request to access the electronic content is received from a content viewer. At block 740, access is controlled based on the access metric and characteristics of the content viewer.

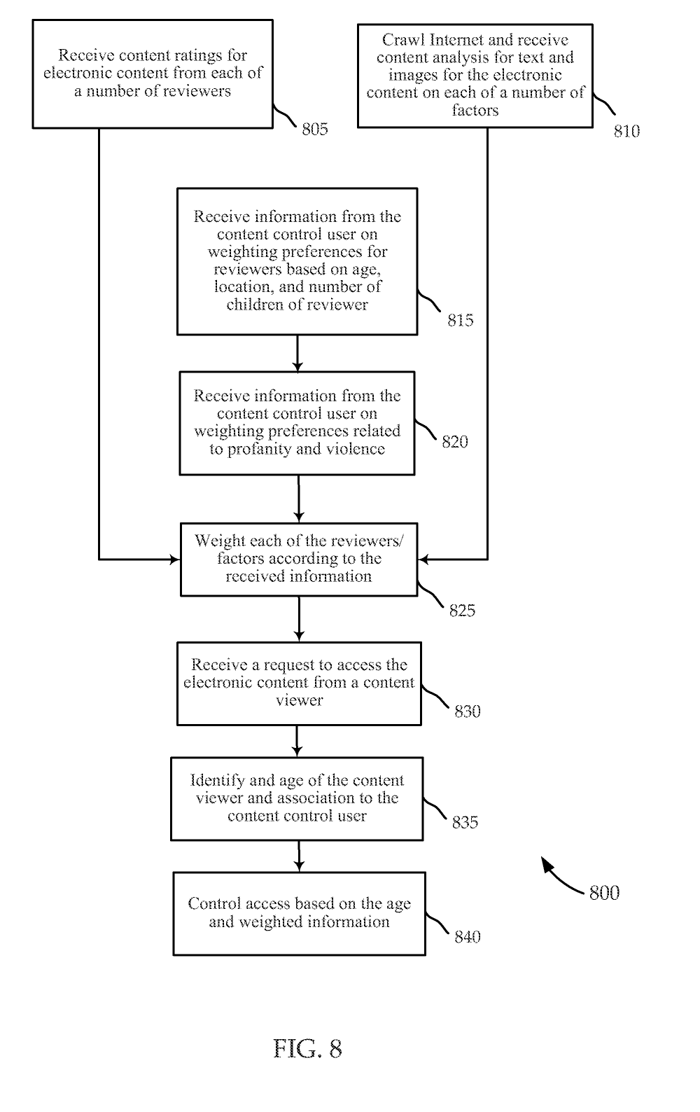

Referring next to FIG. 8, a flowchart is shown illustrating a method 800 for controlling access to electronic content based on preferences of a content control user. The method 800 may be the method 600 of FIG. 6. This method 800 may, for example, be performed in whole or in part by the system 100 of FIG. 1, the content viewer 130 of FIG. 1, the central server computer system 105 of FIG. 1 or 2, or the system 300, 400 of FIGS. 3, 4.

At block 805, content ratings are received for electronic content from each of a number of reviewers. At block 810, the Internet is crawled for text and images of the electronic content, and content analysis on each of a number of factors is received. At block 815, information is received from the content control user on weighting preferences for reviewers based on age, location, and number of children of reviewer. At block 820, information is received from the content control user on weighting preferences related to profanity and violence. At block 825, each of the reviewers/factors is weighted according to the received information. At block 830, a request to access the electronic content from a content viewer is received. At block 835, the content viewer is identified, and his or her age and association with the content control user is identified as well. At block 840, access to the electronic content is controlled based on the age and weighted information.

Aspects described herein may include various wireless communications systems such as CDMA, TDMA, FDMA, OFDMA, SC-FDMA, and other systems. The terms “system” and “network” are often used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1X, 1X, etc. IS-856 (TIA-856) is commonly referred to as CDMA2000 1xEV-DO, High Rate Packet Data (HRPD), etc. UTRA includes Wideband CDMA (WCDMA) and other variants of CDMA. A TDMA system may implement a radio technology such as Global System for Mobile Communications (GSM). An OFDMA system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A, and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies. The description below, however, describes an LTE system for purposes of example, and LTE terminology is used in much of the description below, although the techniques are applicable beyond LTE applications.

The detailed description set forth above in connection with the appended drawings describes exemplary embodiments and does not represent the only embodiments that may be implemented or that are within the scope of the claims. The detailed description includes specific details for the purpose of providing an understanding of the described techniques. These techniques, however, may be practiced without these specific details. In some instances, well-known structures and devices are shown in block diagram form in order to avoid obscuring the concepts of the described embodiments.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof

The various illustrative blocks and modules described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the spirit or scope of the disclosure. Throughout this disclosure the term “example” or “exemplary” indicates an example or instance and does not imply or require any preference for the noted example. Thus, the disclosure is not to be limited to the examples and designs described herein but is to be accorded the widest scope consistent with the principles and novel features disclosed herein.

1. A method of controlling access to electronic content, the method comprising:
receiving a plurality of content ratings for electronic content from each of a plurality of reviewers;
weighting an input value for each of the plurality of reviewers;
receiving content analysis for the electronic content on each of a plurality of factors;
weighting each of the plurality of factors;
combining, using a computer system, the weighted content ratings and the weighted content analysis to generate an access metric; and
controlling, using the computer system, access to the electronic content responsive to the generated access metric.

2. The method of claim 1, further comprising:
identifying an access metric threshold applicable to a content viewer, wherein the controlling access comprises applying the generated access metric to the identified access metric threshold.

3. The method of claim 1, further comprising:
identifying a location,
wherein the weighting of the input value and the weighting of the content analysis comprise weighting the input value and weighting the content analysis according to the location.

4. The method of claim 1, wherein the weighting of the input value and the weighting of the content analysis comprise:
weighting the input value and weighting the content analysis according to a location of a content viewer.

5. The method of claim 1, wherein the weighting of the input value and the weighting of the content analysis comprise:
weighting the input value and weighting the content analysis according an age of a user of a content viewer.

6. The method of claim 1, wherein the weighting of the input value and the weighting of the content analysis comprise:
weighting the input value and weighting the content analysis according to a first weighting for a first daily time period; and
weighting the input value and weighting the content analysis according to a second weighting for a second daily time period.

7. The method of claim 1, wherein the weighting of the input value and the weighting of the content analysis comprise:
weighting the input value and weighting the content analysis according to a type of activity being undertaken by a user of a content viewer.

8. The method of claim 1, wherein the weighting of the input value and the weighting of the content analysis comprise:
weighting the input value and weighting the content analysis according to a specification of a content control user.

9. The method of claim 8, further comprising:
transmitting the content control user a first option to accept community standard for controlling access and a second option for a personalized standard for controlling access; and
receiving, in response to the transmission, the specification for the first option or the second option from the content control user.

10. The method of claim 9, further comprising:
wherein the community standard comprises a content control user-selectable geographic region, or a content control user-selectable organization.

11. The method of claim 1, further comprising:
receiving specification of an access standard applicable to a user of a content viewer from a content control user.

12. The method of claim 11, wherein,
the content control user comprises a parent; and
the user of the content viewer comprises a child of the parent.

13. The method of claim 11, wherein,
the content control user comprises a teacher or education-related entity; and
the user of the content viewer comprises a student.

14. The method of claim 1, further comprising:
receiving a request to access the electronic content from a user of a content viewer, wherein the controlling access comprises applying the generated access metric to characteristics of the user of the content viewer.

15. The method of claim 1, wherein the controlling access comprises:
transmitting an access control message to a content viewer.

16. The method of claim 1, wherein the plurality of factors comprises profanity, violence, sexual content, drug references, and educational value.

17. The method of claim 1, wherein receiving content analysis for the electronic content comprises:
crawling a plurality of web pages to analyze text and images.

18. The method of claim 1, wherein,
the computer system comprises a central server computer system and a content viewer; and
the electronic content comprises internet content, video programming, or electronic gaming.

19. A computer program product for controlling access to electronic content, the computer program product comprising:
a non-transitory computer-readable medium comprising:
code for receiving a plurality of content ratings for electronic content from each of a plurality of reviewers;
code for weighting an input value for each of the plurality of reviewers;
code for receiving content analysis for the electronic content on each of a plurality of factors;
code for weighting each of the plurality of factors;
code for combining the weighted content ratings and the weighted content analysis to generate an access metric; and
code for controlling access to the electronic content responsive to the generated access metric.

20. A system of controlling access to electronic content, the system comprising:
means for receiving a plurality of content ratings for electronic content from each of a plurality of reviewers;
means for weighting an input value for each of the plurality of reviewers;
means for receiving content analysis for the electronic content on each of a plurality of factors;
means for weighting each of the plurality of factors;
means for combining the weighted content ratings and the weighted content analysis to generate an access metric; and
means for controlling access to the electronic content responsive to the generated access metric.

21. The system of claim 20, further comprising:
means for identifying an access metric threshold applicable to a user of a content viewer, wherein the controlling access comprises applying the generated access metric to the identified access metric threshold.

22. The system of claim 20, further comprising:
means for identifying a location of a content viewer,
wherein the means for weighting of the input value and the means for weighting of the content analysis comprise means for weighting the input value and weighting the content analysis according to the identified location.

23. The system of claim 20, wherein the means for weighting of the input value and the means for weighting of the content analysis comprise:
means for weighting the input value and weighting the content analysis according to a geographic region specified by a content control user.

24. The system of claim 20, wherein the means for weighting of the input value and the means for weighting of the content analysis comprise:
means for weighting the input value and weighting the content analysis according to the age of a content viewer.

25. The system of claim 20, wherein the means for weighting of the input value and the means for weighting of the content analysis comprise means for:
weighting the input value and weighting the content analysis according to a first weighting for a first daily time period; and
weighting the input value and weighting the content analysis according to a second weighting for a second daily time period.

26. The system of claim 20, wherein the means for weighting of the input value and the means for weighting of the content analysis comprise:
means for weighting the input value and weighting the content analysis according to a type of activity being undertaken by a content viewer.

27. The system of claim 20, wherein the means for weighting of the input value and the means for weighting of the content analysis comprise:
means for weighting the input value and weighting the content analysis according to a specification of a content control user.

28. The system of claim 27, further comprising:
means for transmitting to the content control user a first option to accept community standard for controlling access and a second option for a personalized standard for controlling access; and
means for receiving, in response to the transmission, the specification for the first option or the second option from the content control user.

29. The system of claim 28, further comprising:
wherein the community standard comprises a content control user-selectable geographic region, or a content control user-selectable organization.

30. The system of claim 20, further comprising:
means for receiving specification of an access standard applicable to a user of a content viewer from a content control user.

31. The system of claim 11, wherein,
the content control user comprises a parent; and
the user of the content viewer comprises a child of the parent.

32. The system of claim 11, wherein,
the content control user comprises a teacher or education-related entity; and
the user of the content viewer comprises a set of students.

33. The system of claim 1, further comprising:
means for receiving a request to access the electronic content from a content viewer, wherein the controlling access comprises applying the generated access metric to characteristics of the content viewer.

34. The system of claim 1, wherein the means for controlling access comprises:
means for transmitting an access control message to a content viewer.

35. The system of claim 1, wherein one or more of the plurality of factors comprise profanity, violence, sexual content, drug references, or educational value.

36. The system of claim 1, wherein the means for receiving content analysis for the electronic content comprises:
means for crawling a plurality of web pages to analyze text and images.

37. The system of claim 1, wherein,
the computer system comprises a central server computer system and a content viewer; and
the electronic content comprises internet content, video programming, or electronic gaming.

38. A device for controlling access to electronic content, the device comprising:
a content reviewer module configured to receive a plurality of content ratings for electronic content from each of a plurality of reviewers;
a content analysis module configured to receive content analysis for the electronic content on each of a plurality of factors;
a weighting module, communicatively coupled with the content reviewer module and content analysis module, and configured to:
weight an input value for each of the plurality of reviewers;
weight each of the plurality of factors; and
combine the weighted content ratings and the weighted content analysis to generate an access metric; and
an access control module, communicatively coupled with the weighting module, and configured to control access to the electronic content responsive to the generated access metric.

39. The device of claim 38, further comprising:
a content control user module, communicatively coupled with the weighting module, and configured to:
transmit to a content control user a first option to accept a community standard for controlling access and a second option to select a personalized standard for controlling access; and
receive, in response to the transmission, a specification for the first option or the second option from the content control user.
